(19) United States
(12) Patent Application Publication
(10) Pub. No.: US 2017/0074392 A1
(43) Pub. Date: Mar. 16, 2017

(54) INTEGRATED MECHANICAL/ELECTRICAL TRANSMISSION PUMP FOR VEHICLES EQUIPPED WITH ENGINE START/STOP SYSTEM

(71) Applicant: BorgWarner Inc., Auburn Hills, MI (US)

(72) Inventor: Robert Francis KELLER, Chesterfield, MI (US)

(21) Appl. No.: 15/252,342

(22) Filed: Aug. 31, 2016

Related U.S. Application Data
(60) Provisional application No. 62/217,336, filed on Sep. 11, 2015.

(51) Int. Cl. F16H 61/00

(52) U.S. Cl. CPC F16H 61/0028

(57) ABSTRACT

A transmission oil pump system is disclosed for a vehicle equipped with an internal combustion engine, an automatic transmission and an automatic stop/start system. The transmission oil pump may include a drive shaft having one end mechanically coupled to the engine by a first clutch module and a second end mechanically coupled to an electric motor by a second clutch module. No additional auxiliary pump or fluid accumulator is required.

### CROSS-REFERENCE TO RELATED APPLICATION

This patent application claims priority under 35 USC §119(e) to U.S. Provisional Patent Application Ser. No. 62/217,336, filed on Sep. 11, 2015.

### BACKGROUND

Technical Field

This disclosure relates to vehicles having an automatic transmission and an automatic engine stop/start system. More specifically, this disclosure relates to a transmission pump for such vehicles wherein the transmission pump may be driven mechanically by the engine, or electrically by an electric motor.

Description of the Related Art

To save fuel and reduce emissions, modern vehicles with internal combustion engines may include an automatic engine stop/start system. Vehicles with a stop/start system include an electronic control unit that switches off the engine when the vehicle comes to a rest for longer than a predetermined time, such as when the driver stops the vehicle for a traffic light. If the vehicle also includes an automatic transmission, the stop/start system may automatically restart the engine when the driver removes foot from brake. On the other hand, if the vehicle is equipped with a manual transmission, the stop/start system may automatically restart the engine when the driver depresses the clutch. This disclosure relates to vehicles equipped with an automatic transmission and an engine stop/start system.

Automatic transmissions include an electrohydraulic system for actuating a variety of elements that collectively actuate a gear shift, such as clutches, brakes, etc. In order to shift gears, the transmission oil pressure must be adequately high and therefore automatic transmissions typically include a transmission oil pump that is normally driven by the engine. Upon starting the engine, it may take a short time period (less than a second) for the transmission oil pump to build up enough oil pressure in the transmission for gear shifting. For vehicles that do not include a stop/start system, this time lag is normally not noticeable to the driver. However, for drivers of vehicles with an automatic transmission and an engine stop/start system, this time lag becomes problematic. For example, after the engine is automatically shut off at a stop light, the time lag needed to build up sufficient oil pressure in order to drive off after automatically re-starting the engine must be as short as possible, because the standard time lag of several tenths of a second would not be acceptable to most drivers. To reduce the standard time lag, manufacturers of vehicles with stop/start systems may include an auxiliary device in the form of an electrically driven auxiliary pump or a fluid storage accumulator to augment the mechanically driven transmission oil pump. Further, the transmission oil pump may be down-sized when used in conjunction with an electric auxiliary pump or a fluid storage accumulator.

Many stop/start systems include a “sailing” function that shuts the engine off when the driver intends to coast. Specifically, within certain speed ranges, the engine is shut off when the driver lifts off or removes his/her foot from the accelerator pedal. Fluid storage accumulators are generally not suitable for use with such stop/start systems that include a sailing function. Therefore, electric auxiliary pumps are generally preferred over fluid storage accumulators for stop/start systems that include a sailing function.

The electric auxiliary pump serves two purposes. First, the auxiliary pump ensures pressurization of the first gear clutch when the engine is restarted after a stop event. Second, for vehicles with a down-sized transmission oil pump, the auxiliary pump may provide additional oil flow as needed for situations where the engine is not driving the transmission oil pump sufficiently fast enough to meet the pressure demands of the automatic transmission.

One disadvantage of automatic stop/start systems is the need for an auxiliary pump or an accumulator, both of which add to the cost of a stop/start system and both of which create space and packaging problems for vehicle designers. Hence, there is a need for an alternative to the use of an auxiliary pump or accumulator in vehicles equipped with an automatic transmission and a stop/start system.

### SUMMARY OF THE DISCLOSURE

In one aspect, this disclosure relates to a transmission oil pump system for a vehicle equipped with an engine, an automatic transmission and an automatic stop/start system. The disclosed transmission oil pump system may include a transmission oil pump that is mechanically coupled to the engine by a first clutch module and that is also mechanically coupled to an electric motor by a second clutch module.

Another transmission oil pump system is disclosed for a vehicle equipped with an internal combustion engine, an automatic transmission and an automatic stop/start system. Further, the automatic transmission of the vehicle may include a hydraulic control unit. Such a disclosed transmission oil pump system may include a transmission oil pump that includes an inlet and an outlet. The inlet may be fluidly connected to a transmission oil reservoir and the outlet may be fluidly connected to the hydraulic control unit of the automatic transmission. The transmission oil pump may include a drive shaft having a first end and a second end. The first end of the driveshaft may be mechanically coupled to the engine by a first clutch module and the second end of the driveshaft may also be mechanically coupled to an electric motor by a second clutch module.

In yet another aspect, a method is disclosed for providing pressurized oil to an automatic transmission of a vehicle equipped with an engine and an automatic stop/start system. One disclosed method may include providing a transmission oil pump that is in fluid communication with the automatic transmission. The transmission oil pump may include a drive shaft that includes a first end and a second end. The method may further include providing a first clutch module that selectively couples the engine to the first end of the driveshaft. The method may further include providing a second clutch module that selectively couples an electric motor to the second end of the driveshaft. When the engine is restarted after a stop event, the method may include coupling the electric motor to the second end of the driveshaft and rotating the driveshaft with the electric motor. Further, when the engine is operating at moderate speeds, the method may include coupling the engine to the first end of the drive shaft and rotating the driveshaft with the engine.

In any one or more of the embodiments described above, the first and/or second clutch modules may be of the overriding type.

In any one or more of the embodiments described above, the electric motor may be powered by a 12-volt battery.

In any one or more of the embodiments described above, the automatic transmission may include a hydraulic control unit that is fluidly connected to an outlet of the pump.

In any one or more of the embodiments described above, the transmission oil pump system does not include an auxiliary pump or an accumulator for augmenting the transmission oil pump.

In any one or more of the embodiments described above, the electric motor may be linked directly or indirectly to the automatic stop/start system.

Vehicles are also disclosed that are equipped with an automatic transmission, an automatic stop/start system and a transmission oil pump system as disclosed herein.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiments illustrated in greater detail in the accompanying drawings, wherein:

FIG. 1 is a schematic illustration of a disclosed transmission oil pump system.

FIG. 2 is another schematic illustration of a disclosed transmission oil pump system.

The drawings are not to scale and may illustrate the disclosed embodiments diagrammatically and in partial views. In certain instances, the drawings omit details which are not necessary for an understanding of the disclosed methods and apparatuses or which render other details difficult to perceive. Further, this disclosure is not limited to the particular embodiments illustrated herein.

### DESCRIPTION OF THE PRESENTLY PREFERRED EMBODIMENTS

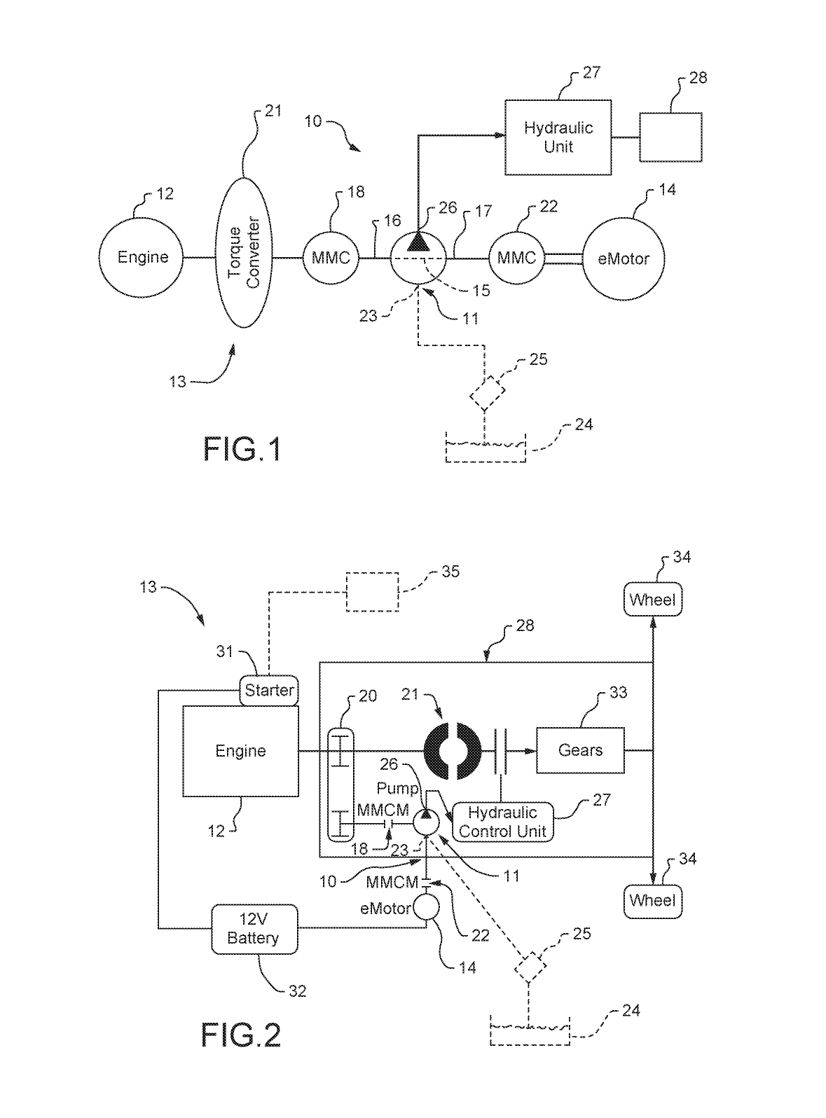

As shown in FIG. 1, a disclosed transmission oil pump system 10 may include a transmission oil pump 11 that is coupled, linked or otherwise selectively connected to both the engine 12 of the vehicle 13 and an electric motor 14. To accomplish this, pump 11 may include a drive shaft 15 having a first end 16 that may be selectively coupled to the engine 12 and a second end 17 that may be selectively coupled to the electric motor 14. For the selective coupling that is required, the system 10 may also include a first clutch module 18 that selectively couples the first end 16 of the driveshaft 15 to a torque converter 21, which in turn, couples the first clutch module 18 to the engine 12. Further, the second end 17 of the driveshaft 15 may be selectively coupled to the electric motor 14 by the second clutch module 22. The transmission oil pump 11 may include an inlet 23 that may be in fluid communication with a hydraulic oil reservoir 24. Flow from the reservoir 24 to the inlet 23 may pass through the filter 25. The transmission oil pump 11 may also include an outlet 26 that may be in fluid communication with the hydraulic unit 27 of the automatic transmission 28 of the automobile 13.

FIG. 2 is another schematic illustration of a vehicle 13 that is equipped with an automatic transmission 28 and an automatic stop/start system 35. The vehicle 13 is also equipped with a disclosed transmission oil pump system 10. The engine 12 may be linked to a starter 31 that may be powered by a 12-volt battery 32. The 12-volt battery 32 may also provide power to the electric motor 14. The engine 12 is coupled directly or indirectly to the torque converter 21, which mechanically couples the engine 12 to the automatic transmission 28. The torque converter 21 also couples the engine 12 to the first clutch module 18. The first clutch module 18 couples the torque converter 21 to the transmission oil pump 11. The transmission oil pump 11 is also mechanically coupled to the second clutch module 22. The second clutch module 22 selectively couples the electric motor 14 to the transmission oil pump 11. The outlet 26 of the transmission oil pump 11 is in fluid communication with the hydraulic control unit 27 of the automatic transmission 28 while the inlet 23 is in fluid communication with a reservoir 24 and filter 25. The automatic transmission 28 also includes a gear set 33 which is mechanically coupled directly or indirectly to a pair of drive wheels 34. As shown in FIG. 2, the starter 31 may be linked or otherwise coupled electrically to an automatic stop/start system 35.

One or both of the clutch modules 18, 22 may be overriding or overrunning clutches. One non-limiting example of such an overriding clutch module is disclosed is U.S. Pat. No. 5,690,202. Other suitable overriding clutch modules will be apparent to those skilled in the art.

### INDUSTRIAL APPLICABILITY

A transmission oil pump system 10 provides adequate oil pressure to the hydraulic transmission 28 regardless of whether the engine 12 is running or has been stopped by an automatic stop/start system 35. The transmission oil pump system 10 includes a single transmission oil pump 11 without an auxiliary pump or fluid accumulator. Instead, the transmission oil pump 11 may be driven mechanically by the engine 12 or electrically by an electric motor 14 that may be powered by a battery 32 of the vehicle 13. Hence, an accumulator or auxiliary pump is not needed and the transmission oil pump system 10 disclosed herein creates fewer packaging or space issues for vehicle designers. The transmission oil pump 11 is coupled to the electric motor 14 via a clutch module 22 and to the torque converter 21 via another clutch module 18. The clutch modules 18, 22 may be of the overriding or overrunning type.

While only certain embodiments have been set forth, alternatives and modifications will be apparent from the above description to those skilled in the art. These and other alternatives are considered equivalents and within the spirit and scope of this disclosure and the appended claims.

1. A transmission oil pump system for a vehicle equipped with an engine, an automatic transmission and an automatic stop/start system, the transmission oil pump system comprising:
a transmission oil pump,
the pump mechanically coupled to the engine by a first clutch module, the pump further mechanically coupled to an electric motor by a second clutch module.

2. The system of claim 1 wherein the first clutch module is an overriding clutch.

3. The system of claim 1 wherein the second clutch module is an overriding clutch.

4. The system of claim 1 wherein the first and second clutch modules are overriding clutches.

5. The system of claim 1 wherein the electric motor is powered by a 12 volt battery.

6. The system of claim 1 wherein the transmission includes a hydraulic control unit and the pump is fluidly connected to the hydraulic control unit.

7. A vehicle equipped with an automatic transmission, an automatic stop/start system and the transmission oil pump system of claim 1 wherein the transmission oil pump system does not include an auxiliary pump or accumulator to augment the transmission oil pump.

8. A transmission oil pump system for a vehicle equipped with an internal combustion engine, an automatic transmission and an automatic stop/start system, the automatic transmission including a hydraulic control unit, the transmission oil pump system comprising:
a transmission oil pump including an inlet and an outlet, the inlet fluidly connected to a transmission oil reservoir, the outlet fluidly connected to the hydraulic control unit of the automatic transmission, the transmission oil pump including a drive shaft having a first end and a second end,
the first end of the drive shaft mechanically coupled to the engine by a first clutch module, the second end of the drive shaft further mechanically coupled to an electric motor by a second clutch module.

9. The system of claim 8 wherein the first clutch module is an overriding clutch.

10. The system of claim 8 wherein the second clutch module is an overriding clutch.

11. The system of claim 8 wherein the first and second clutch modules are overriding clutches.

12. The system of claim 8 wherein the electric motor is powered by a 12 volt battery.

13. The system of claim 8 wherein the electric motor is linked to the automatic stop/start system.

14. A vehicle equipped with an automatic transmission, an automatic stop/start system and the transmission oil pump system of claim 8 wherein the transmission oil pump system does not include an auxiliary pump or accumulator to augment the transmission oil pump.

15. A method for providing pressurized oil to an automatic transmission of a vehicle equipped with an engine and an automatic stop/start system, the method comprising:
providing a transmission oil pump that is in fluid communication with the automatic transmission, the transmission oil pump including a drive shaft, the drive shaft including a first end and a second end;
providing a first clutch module that selectively couples the engine to the first end of the drive shaft;
providing a second clutch module that selectively couples an electric motor to the second end of the drive shaft;
when the engine is restarted after a stop event, coupling the electric motor to the second end of drive shaft and rotating the drive shaft with the electric motor; and
when the engine is operating at moderate speeds, coupling the engine to the first end of the drive shaft and rotating the drive shaft with the engine.
